(19) United States
(12) Patent Application Publication
(10) Pub. No.: US 2003/0056657 A1
(43) Pub. Date: Mar. 27, 2003

(54) Method and means for selectively cooling an extrusion die head

(76) Inventors: Richard Jarvis Warner, Boca Raton, FL (US); Daniel Thompson, Roscoe, IL (US)

Correspondence Address: JAMES VAN SANTEN, 720 NATWILL SQUARE, GENEVA, IL, 60134-2073, US

(21) Appl. No.: 09/963,624

(22) Filed: Sep. 27, 2001

(51) Int. Cl. A23P 1/00

(52) U.S. Cl. 99/353

(57) ABSTRACT

The temperature of an extrusion die head having a stator means is selectively controlled as a function of the bulk density of the final extruded product, thereby to maintain the bulk density at a targeted value by regulating the temperature of the extruding product. A programmable logic computer for regulating a multi-tasking processor to constantly monitor, control, and display speed, head gap position, gross temperature, feed rate and target moisture additionally regulates the flow of cooling liquid through a water jacket formed in the stator means of the extruder die head surrounding the extrusion die opening or gap.

### BACKGROUND OF THE INVENTION

1. Field of the Invention

This invention relates to a method and means for making food products such as snack foods, pastas, cereal and pet food formed by extrusion, and more particularly to a method and means of controlling the temperature of an extrusion die head through which the food material passes, which in turn, improves control of the ultimate bulk density of the extruded food product.

2. The Prior Art

The prior art is exemplified by U.S. Pat. No. 5,143,738 issued Sep. 1, 1992 entitled “Computerized Food Product Extrusion Machine and Method,” and by U.S. Pat. No. 6,210,727 issued Apr. 3, 2001, entitled “Method and Means of Controlling a Food Extruder as a Function of Bulk Density of the Extruded Product,” both owned by the assignee of the present invention.

In the production of extruded food products, the bulk density of the ultimate final product is critically important to the quality of the product. Practitioners in the art recognize that there are a number of variable factors which influence the bulk density of the extruded final product. For example, the extruder machine is controlled by a Programmable Logic Computer (PLC) which constantly monitors the temperature of the raw material delivered to, and glutinized in, the extruder; the speed of the screws driving the raw material to the extruder head, the head gap position of the extruder die head through which the raw material passes, the feed rate, and the target moisture of the material.

### SUMMARY OF THE INVENTION

We have discovered that the heated and pressurized glutinized raw material and the extruder die head, which usually comprises a stator in the form of a heavy solid metal article made of thermally conductive metal, tend to approach a common equilibrium temperature during operation of the extruder machine. Because of the bulk and the weight of the extruder head stator, it tends to form a heat sink so that it's retained temperature definitely affects the temperature of the material extruding through the extruder die head gap. If retained thermal energy is at too high a level, the bulk density of the final product will be adversely affected.

Accordingly, in order to achieve a higher degree of sophistication in the control of the temperature of the extruding material passing through the extruder gap in the extruding head, we have provided a means of directly controlling the temperature of the extruder head stator as a reciprocal function of the bulk density of the final food product. In regulating the temperature of the extruder head, the extruder head, in turn, more closely controls the temperature of the extruding material. Thus, we achieve a higher degree of accuracy in the targeted bulk density of the final food product, with a consequent improvement of the bulk density standards sought by the users of the extruder machines.

In U.S. Pat. No. 6,210, 727, there is described a bulk density measuring device whereby the bulk density of the formed product can be automatically calculated. On the basis of such calculation, a control signal is generated and the PLC, in response to such signal makes adjustments as may be required to regulate head gap position, feed rate and target moisture.

By the present invention, we provide a temperature conditioning jacket, or flow passage, extending circumferentially around the die opening formed in the stator of the extruder head, and through which jacket, or passage, we direct a temperature conditioning flow of liquid, such as water. We place the PLC in control of the volume flow of temperature conditioning liquid through the jacket, or passage, of the extruder head stator, thereby achieving a controlled flow of liquid through the jacket which flow volume is a function of the bulk density of the final product. As a result, the temperature of the extruding material passing through the extruder head gap is reciprocally precisely controlled and the production of a high quality final product of the desired bulk density is assured.

For example, we achieve such temperature control by directing cooling liquid, such as water, through said jacket, thereby to selectively cool the extruder head stator to an optimum temperature. In turn, the extruder head stator will adjustably regulate the temperature of the material passing there through and extruding though the head gap to maintain such material at an optimum extruding temperature necessary to achieve a selected targeted bulk density value of the final product.

### DESCRIPTION OF THE DRAWINGS

FIG. 1 is an end elevational view, with parts removed and/or with parts broken away, and with schematic wiring control circuitry added, showing elements of a food extruder system of the type used for extruding snack foods, pastas, cereals and pet foods, and incorporating an extruder die head construction embodying the principles of this invention and capable of practicing the method this invention.

FIG. 2 is a side elevational view of an automated extruder used in the system of FIG. 1.

FIG. 3 is an enlarged, fragmentary cross-sectional view of the extruder head illustrating additional details of the stator and rotor utilized in the extruder of FIG. 2, and,

FIG. 4 is a fragmentary view showing the face of the stator portion of the extruder head provided in accordance with this invention modified to incorporate a water jacket and a water cooling system.

FIG. 5 is a cross-sectional view taken on line A-A of FIG. 4 but with the face plate and other parts removed from the stator.

### DESCRIPTION OF THE PREFERRED EMBODIMENTS

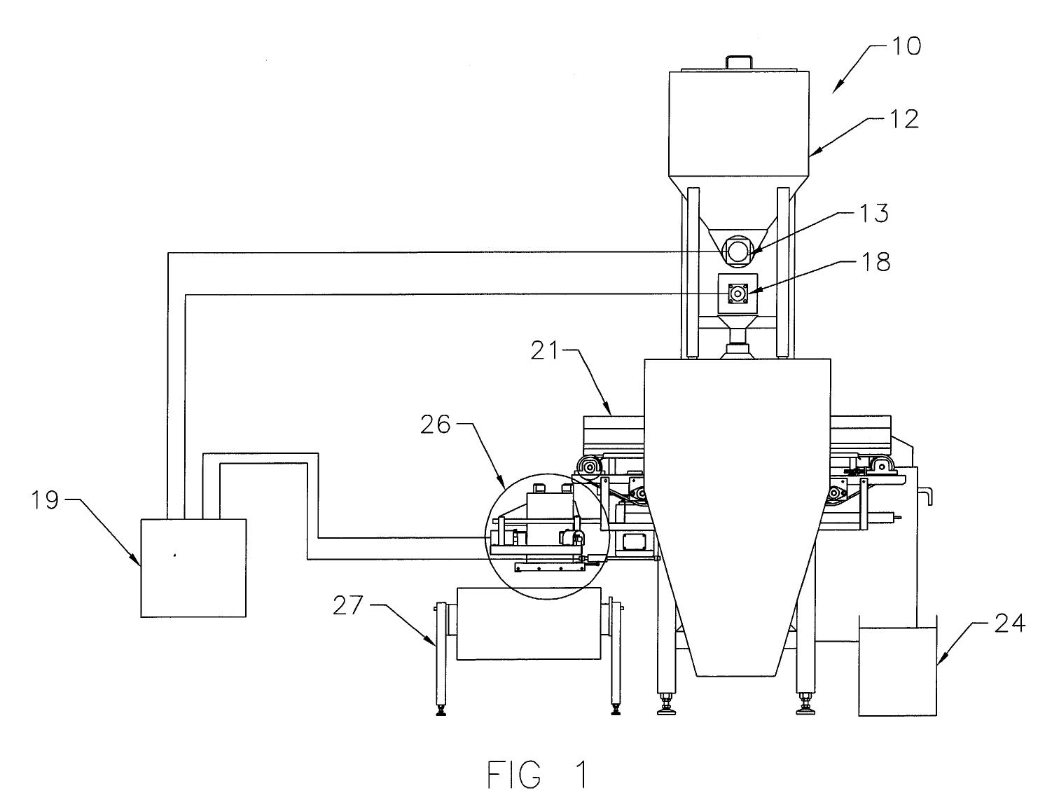

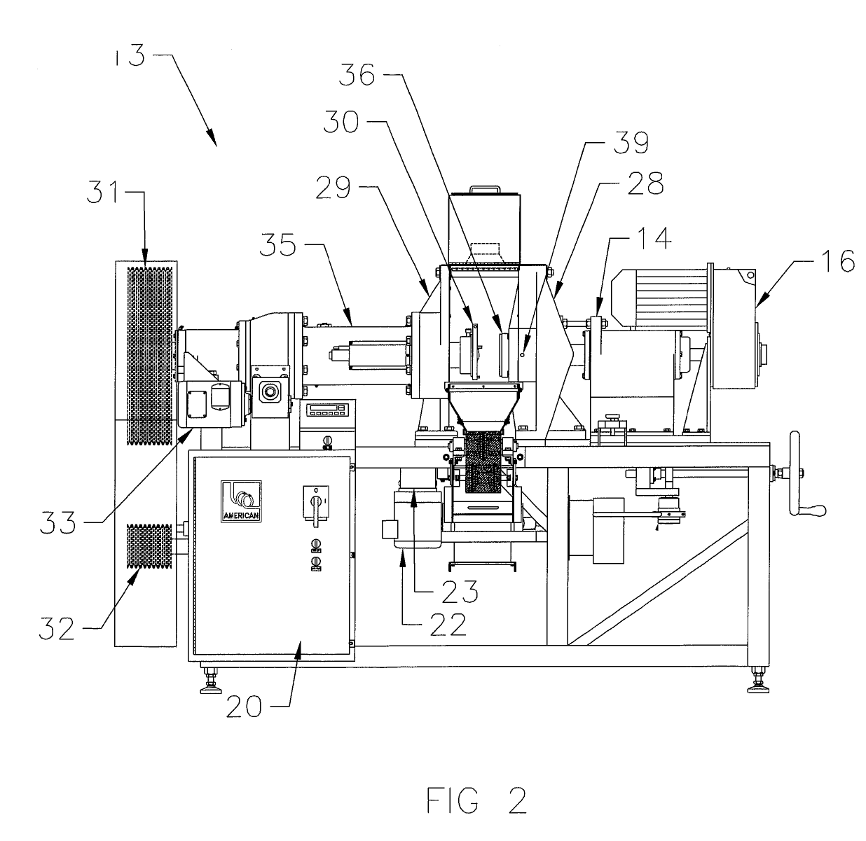

Referring to FIGS. 1 and 2 of the drawings, there is shown an exemplary form of a typical system utilizing a food extruder 10 of the type wherein raw material is extruded to make a formed food product such as a snack food. The extruder 10 provides the environment in which the extruding die head improvements of the present invention find greatest utility.

While the food extruder and the principles of the present invention are applicable to the manufacture of any food product such as snack foods, pastas, cereals and pet foods, the exemplary system and machine components herein described is of the type sometimes referred to as a fry-type extrusion line utilized in the production of snack foods. Essentially, it is contemplated that a processing stream be established, starting with raw material, such as corn grain.

At a first point in the processing stream the corn grain is supplied to a vertical mixer where moisture is added to the raw material, such as corn meal, prior to transport to a second point in the processing stream in which the moistened corn meal is conveyed to a hopper of the food extruder 10, for example, a vibrating stainless steel hopper 12.

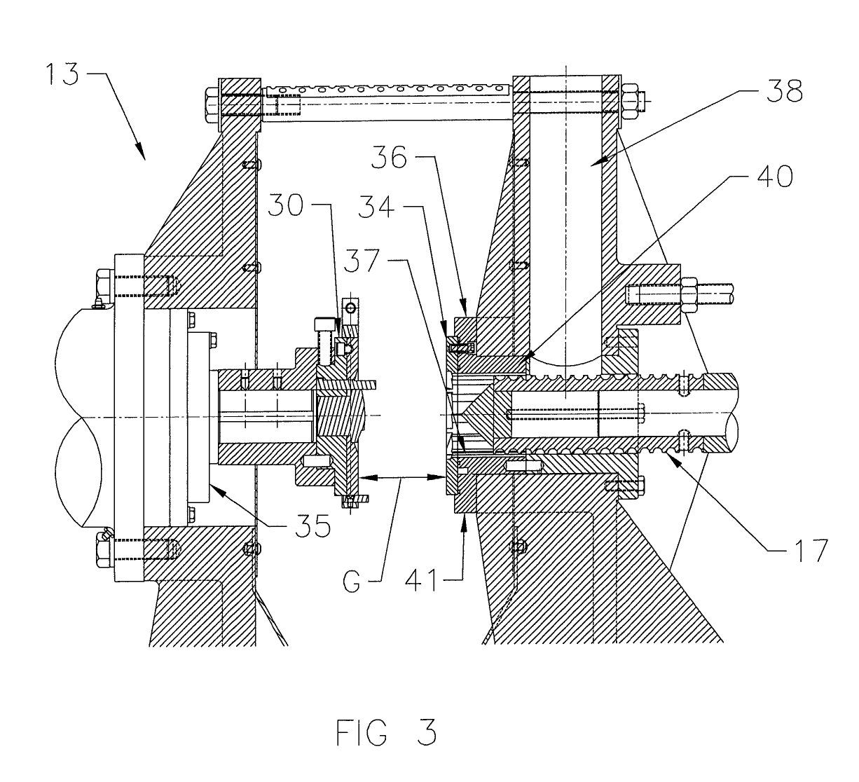

Referring now to FIGS. 2 and 3, there is provided an extruder shown generally at 13 and which actually constitutes the third point in the processing stream. The raw material is transferred from the hopper 12 to a feed screw drive assembly 14 having a feed screw drive 16 which rotatably drives a feed screw 17 to force material forwardly for actual extrusion. The control of a moisture control system 18 is regulated by a computer means having a programmable logic controller 19 (PLC) shown schematically in FIG. 1, but located in a control box designated in FIG. 2 at 20.

Vibrator means provided on the hopper 12 assist in moving grain to a conduit having an outlet in which is situated a moisture probe comprising one or more dielectric sensors by means of which the moisture content of the grain is measured. A water delivery system in the moisture control system 18 adds water to the grain to bring the moisture content thereof up to an optimum required level for accomplishing quality extrusion.

In operation, the moisture control system 18, or the probe of that system, generates an analog moisture content signal which is sent to the PLC 19 in which the signal is compared with the preselected desired moisture content. A differential signal resulting from the comparison is digitized and is used to control the delivery of water to the metering feeder.

The feed screw 17 comprises a helical screw that is driven by the feed screw drive 16 of the feed screw drive assembly 14 at infinitely adjustable variable speeds, all of which mechanism is under the control of the PLC 19. The amount of water flow delivered by the water delivery system is controlled in proportion to the quantum of grain transported out from the hopper 12 to the extruder 13 so that the formed product has the requisite characteristics of shape, form and density.

As in the extruder referred to in U.S. Pat. No. 6,210,727, the raw material is processed by being extruded through an adjustable die head gap, also under the control of the PLC 19. The extruded material is then discharged as a formed final product to a take-away conveyor 21 driven by a conveyor motor 22 through a conveyor reducer 23.

As in U.S. Pat. No. 6,210, 127, the formed product is discharged continuously onto the take-away conveyor 21 which forms a downstream component of the processing stream. The take-away conveyor 21 is reversible and the machine as described has an automatic start-up. The PLC 19 prepares raw material, adjusts the head gap, feeds the raw material, controls the gross temperature of the material and reverses the discharge belt of the take-away conveyor 21 so irregular product is caught in a waste bin 24.

A bulk sampling means shown generally as contained within an inset 26 (FIG. 1) are interposed in the processing stream and discharge extruded product onto a discharge conveyor 27. The bulk sampling means within the inset 26 corresponds to the structure disclosed and claimed in U.S. Pat. No. 6,210,127 and temporarily obstructs a passage through which the processing stream is directed to collect and weigh a known volume of product upon which to base a calculation of bulk density. Since the details of such bulk sampling means 26 correspond to those fully described in U.S. Pat. No. 6,210,727, they need not be repeated herein and such description is incorporated by reference. It will be understood that a control signal is generated for regulating a multi-tasking processor of the PLC 19 for monitoring purposes.

Referring further to FIG. 2 in conjunction with FIG. 3, it will be noted that the extruder 13 has a stator support 28 and a rotor support 29. A rotor 30 is rotatably driven by a rotor pulley 31 belted to a motor driven drive pulley 32.

An adjusting motor 33 mounted on the rotor support 29 is controlled by the PLC 19 and operates to adjust a rotor assembly 35 carrying the rotor 30 longitudinally on its axis of rotation towards and away from a face 34 formed on a stator 36 stationarily mounted on the stator support 28. The stator 36 has a center axis longitudinal opening 37 complemental in size to the outer diameter of the feed screw 17 and extends to communicate with an inlet passage 38 through which raw material suitable for extrusion is directed.

The actual extrusion gap is marked “G” and may be varied in effective size depending on the relative position of the rotor 30 and the face 34 of the stator 36. A temperature probe 39 is located at the end of the inlet passage 38 just adjacent the extrusion head and measures the temperature of the raw material at the stator 36. While the PLC 19 utilized in an arrangement similar to that of the prior art was capable of responding to temperature signals generated by a probe similar to the probe 39 and adjusting the gross temperature of the glutinized raw material, it would automatically bring the head gap into position for approximate control of the bulk density. However, the resultant bulk density of the final product was still variable within a range of from about 10% to 15%.

In accordance with this invention, the range of variation from a targeted bulk density is minimized, if not actually completely eliminated, a result which is achieved by closely controlling the temperature of the die head, and specifically that of the stator 36 through which the material to be extruded passes to the gap “G.”

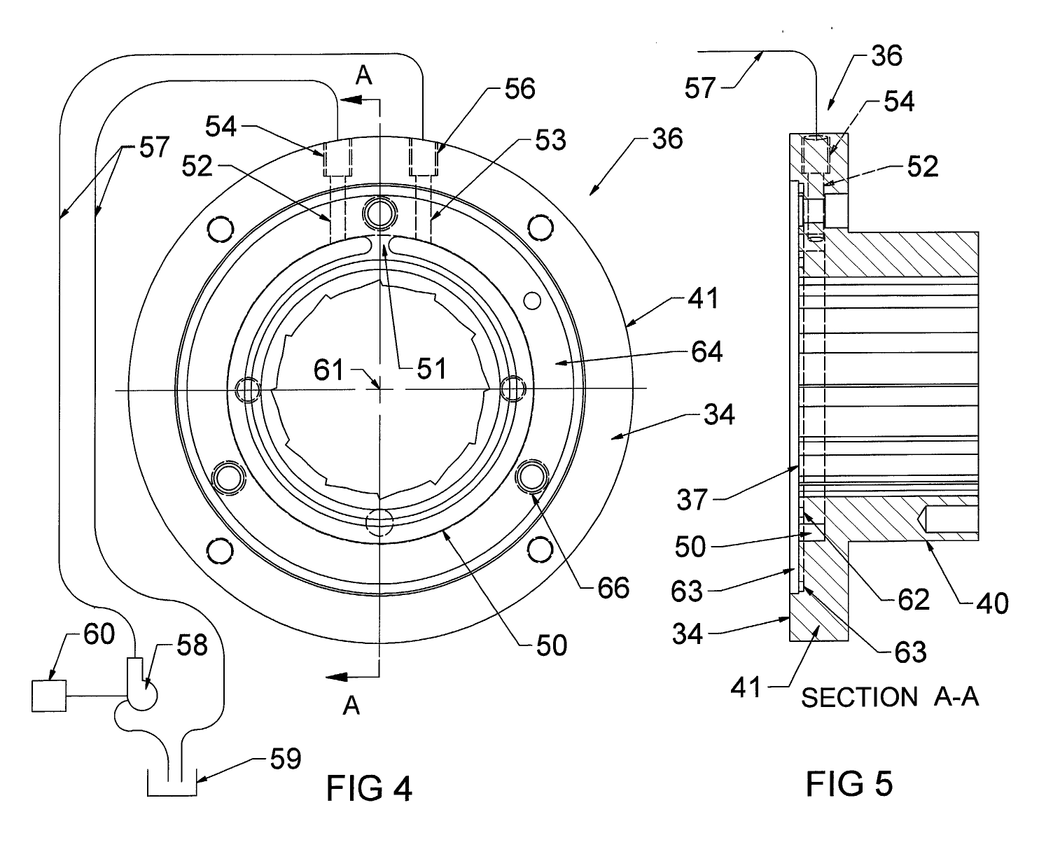

In FIGS. 3 and 4 of the drawings, the stator 36 of the extruder die head is shown. The die head is generally designated by the extruder 13 and constitutes a stator 36 which is a heavy metal cylindrically shaped article having a longitudinally extending body 40 with a radially extending circumferentially uniform flange 41 at one end. The flange 41 has a flat end surface forming the face 34. The stator opening 37 extends through the stator 36 on a center line axis 61 (FIG. 4) of the stator 36 from an inlet end communicating with the inlet passage 38 and intersects the face 34.

In order to provide a separate independent temperature conditioning means for the extruder head 13, and specifically the stator 36, there is formed in the stator 36 a water jacket, or flow passage 50, which is spaced radially outwardly of the opening 37 and its center axis, but radially inwardly of the outer periphery of the flange 41. The water jacket is also longitudinally inward of the face 34. The jacket or passage 50 is circumferentially discontinuous, i.e., it has respective end portions that are spaced apart from one another as at 51. A pair of radially outwardly projecting passages are formed to extend respectively from each end of the jacket or passage 50 to form an inlet port 52 and an outlet port 53. The ports 52 and 53 are each provided with internally threaded exit junctions as shown at 54 and 56 so that the jacket or passage 50 may be mechanically and hydraulically coupled to a water circulation system having conduit means 57. A circulating pump 58 with its own water supply reservoir 59 is controlled by a signal responsive regulator 60 under the control of the PLC 19 and operates to drive water through the conduit means 57 to the jacket 50. Inner and outer “O” ring recesses 62 and 63 are provided in the stator face 34 and a stator face plate 64 fits in a complementally shaped recess 63 provided for it in the face 34. The face plate 64 is connected in firm assembly with the stator 36 with appropriate fasteners 66 so that the the jacket 50 is sealed against leakage into the gap “G.”

We have discovered that the flow rate of water through the jacket or passage 50 is more critical than the specific temperature of the water directed there through. For example, in a typical system for the manufacture of a snack food, the temperature of the raw material when glutinized will be in the range of approximately 350 to 360 degrees Fahrenheit. During operation of the system, the heavy metallic stator body 36 of the extruder die head 13 tends to approach the temperature of the raw material passing through the stator 36 to the adjustable gap “G.” In this regard, it appears that the stator 36 of the extruder die head 13 tends to form a heat sink. We have further discovered that once the stator 36 reaches an elevated temperature, it tends to maintain the raw material at that temperature, even after the PLC 19 has signaled lowering of the gross temperature of the raw material. Accordingly, the stator 36 may exert a lagging effect on the temperature control of the extruding raw material.

However, we have also discovered that as long as the water stream directed through the jacket or passage 50 is less than the temperature of the raw material, the stator 36 is capable of serving as an excellent heat exchanger and is an excellent control instrumentality with regard to achieving precise control of the temperature of the extruding material, and hence precise control of the bulk density of the final product.

The PLC 19 preferably utilizes a code which directs the execution of sampling bulk density in a random manner to obtain optimum statistical process control. Frequent samples are taken of the formed product in the material processing stream by the bulk density sampling means 26. The samples are automatically measured and analyzed. The information developed is utilized by the algorithm programmed into the PLC 19 to adjust and control various aspects of the manufacturing variables.

In operation, the PLC receives a bulk density signal which is compared to an optimum preselected desired bulk density value. On the basis of such comparison, the PLC 19 makes such adjustments to the regulator 60 so that the flow rate of water drawn from the reservoir 59 and directed by the pump 58 through the jacket or passage 50 is selectively varied and will precisely control the temperature of the extruding material passing through the adjustable gap “G.” By optimizing the temperature of the extruding material, the bulk density of the final product is correspondingly closely regulated.

For example, in a typical snack food manufacturing process using a system as herein disclosed, the user of the system has heretofore expected to achieve a bulk density of the final product in the range of 4.25 to 4.75 pounds per cubic foot. With the machine of the present disclosure and utilizing the principles of the present invention it is possible to achieve any selected value of bulk density targeted within that range, say 4.5, with great accuracy and reliability.

It will be understood that if the gross temperature of the raw material is low, i.e., relatively cool, then the PLC 19 will sense the condition and little, if any, flow through the jacket, or passage 50 will occur. On the other hand, if the temperature rises to a level adversely affecting the bulk density of the final product, a flow of cooling water through the jacket 50 will be initiated and the amount of that flow will be regulated in response to the variations in the bulk density of the final product.

The extrusion die head stator 36, being made of thermally conductive material, functions as a heat exchanger. Thus, the cooling flow of water passing through the jacket 50 absorbs thermal energy by conduction and carries such thermal energy away from the stator 36 where it is dissipated at a location remote from the die head 13.

Although minor modifications might be suggested by those versed in the art, it should be understood that we wish to embody within the scope of the patent warranted hereon all such modifications as reasonably and properly come within the scope of our contribution to the art.

We claim as our invention:

1. A method of making an extruded snack food which includes the steps of:
(A) gelatinizing a corn meal with heat and moisture to form an extrudable raw material at an elevated temperature,
(B) transporting the raw material under pressure to the die extrusion gap of an extrusion die head,
(C) providing an extrusion die head construction of thermally conductive material,
(D) flowing the raw material through the die extrusion gap in a continuous stream so that the extrusion die head and the raw material tend to approach a common equilibrium temperature, and,
(E) selectively cooling the extrusion die head to closely control the temperature of the extruding raw material,
whereby the bulk density of the final extruded product will be controlled to achieve a targeted optimum value.

2. The method of claim 1, wherein step (E) is effected by flowing a stream of water through the stator portions of the extrusion die head so that thermal energy is removed to a location remote from the die head by conduction.

3. The method of claim 2, wherein the gross temperature of the raw material in step (A) is elevated to a temperature in the range of from about 350 to 360 degrees Fahrenheit.

4. The method of claim 3, wherein the temperature of the stream of water is at least less than 350 degrees Fahrenheit.

5. For use in a food product extruding machine of the type having means for supplying glutinized corn meal to an extrusion die gap at a temperature elevated to a range of from about 350 to 360 degrees Fahrenheit for extrusion as a snack food, the improvement of:
an extrusion die head having a die opening gap through which the extruding material passes,
said extrusion die head having stator means made of material which has sufficient mass, density and thermal conductivity so that it tends to form a heat sink which, in continuous extrusion operation, approaches the temperature of the extruding material passing there through,
water jacket means formed in said stator means of said extrusion die head, and
a water supply system connected to said water jacket means to selectively flow a stream of water at lesser temperature than the temperature of the extruding material,
whereby the extruding material is temperature controlled as it passes through the extruder to a temperature at which bulk density of the final extruded product is optimized.

6. The extrusion die head of claim 5 wherein
said water jacket means comprises a passage formed in said stator
means to extend in radially spaced relation to a center axis opening in said stator means and extending circumferentially from a pair of radially extending passages forming an inlet and an outlet.

7. The extrusion die head of claim 6 wherein
said water supply system comprises a pump having its own reservoir, and conduit means from said inlet and said outlet connected to said pump and to said reservoir.

8. A food product extruding machine of the type defined in claim 5, and further characterized by,
product flow processing means including bulk density sampling means receiving the extruded product from said die head,
said bulk density sampling means having means for generating a signal which is a function of final product bulk density, and
programmable logic computer means to monitor, control and display the parameters of speed , head gap position, gross temperature, target moisture and feed rate of the machine,
said computer means operatively controlling the flow of water through said passage as a function of the bulk density of the final extruded product and the temperature of the extruding material.

9. In a programmable logic computer means for monitoring, controlling and displaying speed, head gap position, temperature, feed rate and target moisture in a food extruding machine of the type wherein raw material is extruded to form a product,
the improvement of,
bulk density measuring means generating a control signal which is a function of the bulk density of the final extruded product, and,
computer control means responsive to said control signal to regulate the flow of a cooling stream of water flowing through the stator means of a die extrusion head, thereby to control the temperature of the die extrusion head.

10. An extruding machine, comprising,
an extrusion die head having stator means with an axial opening surrounded by a water jacket,
a water system for selectively flowing water through said water jacket to control the temperature of the stator means,
product flow means forming a product stream to flow glutinized raw material at elevated temperature through said stator means of said die head and extruded product from said die head,
bulk density measuring means in said product stream to generate a bulk density signal of the final extruded product,
a programmable logic computer responsive to said bulk density signal,
and means in said water system subject to the control of said programmable logic computer to regulate the flow of water through said water jacket, thereby to control the temperature of the die head and the bulk density of the final product.

11. The method of manufacturing a food product in the group of food products which includes snack foods, Pastas, cereal and pet food, which method includes the steps of:
(A) heating a supply of selected raw material to a predetermined temperature at which the raw material constitutes a flowable glutinized mass,
(B) pressurizing the flowable mass to flow the raw material through the extrusion gap of a thermally conductive extrusion head whereby the flowable mass and the extrusion head attain a common temperature, and
(C) selectively cooling the extrusion head to regulate the temperature of the extruding raw material and to thereby control the bulk density of the final extruded product.

12. The method of claim 11 wherein the extrusion head is provided with a heavy metal stator means through which the material to be extruded passes, and,
step (C) is carried out by flowing water through a water jacket passage formed in the stator means.

13. A stator for a food extrusion head comprising,
a metal cylindrically shaped article having a longitudinally extending body with a radially extending circumferentially uniform flange at one end thereof,
a stator opening formed in said stator extending on the center line axis thereof from an inlet end to the face,
a water jacket spaced radially outwardly of the opening and its center line axis and inwardly of the outer periphery of said flange,
said water jacket being circumferentially discontinuous, and,
a pair of radially outwardly projecting passages formed to extend outwardly from each corresponding end providing an inlet and an outlet to which a pressurized water system may be connected.

14. A stator as defined in claim 13, and wherein a water system is connected to said inlet and said outlet,
said water system comprising a circulating pump with its own water supply reservoir and
a signal responsive regulator under the control of a PLC in control of said pump,
whereby the water system operates to drive water through the jacket under the control of the PLC.
